(19) United States
(12) Patent Application Publication
(10) Pub. No.: US 2022/0069529 A1
(43) Pub. Date: Mar. 3, 2022

(54) NOISELESS CONNECTOR FOR ACTIVE AND PASSIVE AUDIO COMPONENTS

(71) Applicant: KLOS Innovations, LLC, Provo, UT (US)

(72) Inventors: Adam Henry Klosowiak, Provo, UT (US); Ian Tom Klosowiak, Provo, UT (US)

(21) Appl. No.: 17/002,724

(22) Filed: Aug. 25, 2020

(51) Int. Cl. H01R 13/70; H01R 24/58

(52) U.S. Cl. CPC H01R 13/70; H01R 24/58

(57) ABSTRACT

An improved audio connector, providing reliable muting when inserted into mono and stereo jacks comprises a tip member, a sleeve member having a through-hole, an insulating collar, and a mute switch with a switching lobe passing through the through-hole to release an electrical connection between the tip member and sleeve member, upon proper insertion of the audio connector into a mono or stereo jack.

### TECHNICAL FIELD

The present disclosure relates to componentry for handling electric audio signals. More specifically, this disclosure relates to a noiseless connector for active and passive audio components.

### BACKGROUND

The tip-sleeve (“TS”) or phone connector, in particular, the ¼ inch TS connector has, for almost a century, been a standard interface for cables connecting electric instruments and accessories. Using standard quarter-inch cables, one could, for example, connect Charlie Christian's Gibson ES-150 through Jimi Hendrix's Roger Meyer Octavia Pedal to a USB audio interface of a computer running the latest recording and signal processing software, and reasonably expect a crackle-free connection across 90 years of audio hardware. The TS connector's simplicity, reliability and ruggedness have ensured its status as a standard connector for a wide variety of audio equipment for over a century.

However, a persistent weak spot in the TS connector's design is that, in a standard TS plug, the tip and sleeve connector portions form an open circuit. A practical consequence of this open circuit is that unwanted signals can be generated through contact between the tip portion of a TS plug and other surfaces. As one example, a “clicking” type sound can be obtained by plugging one end of an instrument cable into an audio amplifier and tapping the tip of a TS plug at the other end of the cable with one's finger. At the same time, when the tip is grounded (i.e., electrically connected to) the sleeve portion of the exposed TS plug, the above-described “clicking” sounds can no longer be produced.

Similarly, an ear-splitting “popping” sound can be produced when “hot-swapping” components connected to live amplifiers—for example, by unplugging the cable connecting a first instrument to an amplifier from the first instrument and plugging the cable into a second instrument. In such cases, intermittent contact between the tip of the TS plug and a ground contact of the instruments' TS jacks can create signals based on transient spikes in the potential difference between the tip contact and sleeve contacts of the amplifier jack, which are reproduced and amplified by the amplifier as loud, harsh-sounding “pops.”

Signals from such transient spikes in potential difference across the sleeve and tip portions of a TS jack during insertion of a standard TS plug are multiply undesirable in that the “popping” sounds such spikes produce, when amplified, not only sound unpleasant, but can also damage equipment, such as the paper speaker cones of vintage amplifiers, as well as metal woofer cones, which are not designed to reproduce signals with significant high frequency components.

Further, the increased adoption of active pickups or other transducers with a built-in preamplifier or other upstream processing circuitry has heightened the problems associated with unwanted sounds and other transient signals while connecting “hot” audio components. In many cases, instead of a two-lead “mono” TS jack, instruments with active pickups utilize a three-lead “stereo” jack with a sleeve contact, a ring contact and a tip contact. As such, “stereo” TS jacks provide additional opportunities for sharp, transient signals created from unwanted contact between the ungrounded plug of a TS plug and the sleeve and ring contacts of the jack during insertion of the plug. Additionally, existing “noiseless” TS plugs (for example, the NEUTRIK® “Silent Plug” or designs by GIG-FX™) present unacceptable tradeoffs between limited durability arising from components ill-suited to the demands of working musicians, such as sliding collar portions or reed switches and failing to reliably stop the dreaded “pop” from transient changes in potential at the plug tip when used in stereo jacks.

Accordingly, achieving simultaneously satisfactory durability and consistent noise suppression in both stereo and mono TS jacks remains a source of technical challenges and opportunities for improvement in the art.

### SUMMARY

The present disclosure illustrates embodiments of a noiseless connector for active and passive audio transducers.

In a first embodiment, an audio connector includes a tip member, comprising a section of conductive material. The tip member includes an external portion with an external profile defining a tip and a radial groove, and an internal portion having a first end and a second end, and a switch region disposed between the first end and the second end. The first end of the tip member abuts the external portion, and the second end is configured to form a first connection with a first section of cable. The audio connector also includes a sleeve member comprising a substantially cylindrical hollow section of conductive material. The sleeve member a first end proximate to the tip member, a second end distal to the tip member, and a through-hole. The sleeve member is configured to form a second connection with a second section of cable. The audio connector has an insulating collar having a substantially cylindrical, hollow section of insulating material, and includes a first end, wherein the first end of the insulating collar has a flange having a thickness, and a second end. The exterior radius of the insulating collar is less than an interior radius of the sleeve member, and the interior radius of the sleeve member is greater than a thickness of the internal portion of the tip member. The audio connector also includes a mute switch made of a section of a flexible, conductive material. The mute switch further includes a retaining portion with an interior profile configured to contact an exterior profile of the insulating collar, and an exterior profile configured to contact an interior profile of the sleeve member. Additionally, the mute switch includes a switch arm portion having a first end and a second end, such that the first end of the switch arm portion joins the retaining portion. A switching lobe is disposed on the switch arm portion proximate to the second end at a location allowing at least part of the switching lobe to pass through the through-hole in the sleeve member at a first distance between a leading edge of the switching lobe and the first end of the sleeve member. The mute switch includes a contact arm portion disposed proximate to the second end of the switch arm portion, wherein the switch arm portion is configured to maintain electrical contact between the contact arm portion and the switch region of the tip member when the switching lobe is not sufficiently depressed, and wherein the switch arm portion is configured to release electrical contact between the contact arm portion and the switch region of the tip member when the switching lobe is sufficiently depressed.

In a second embodiment, an audio connector includes tip means for forming a first connection with a first section of cable and sleeve means for forming a second connection with a second section of cable wherein the sleeve means comprises a first end proximate to the tip means and a second end distal to the tip means. The audio connector also includes insulating means for separating the tip means from the sleeve means, wherein the insulating means has a flange having a thickness. The audio connector also includes mute switch means for maintaining an electrical connection between the tip means and the sleeve means until the tip means is inserted past a pop point of an audio jack. The mute switch means includes a switching lobe disposed at a first distance between a leading edge of the switching lobe and the first end of the sleeve means.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate an example of a TS plug and a simplified circuit illustrating aspects of the technical challenges addressed by certain embodiments as claimed by this disclosure;

FIGS. 2A-2D illustrate aspects of technical problems addressed by certain embodiments according to this disclosure in the context of a mono phone jack;

FIGS. 3A-3D illustrate aspects of technical problems addressed by certain embodiments according to this disclosure in the context of a stereo phone jack;

FIG. 4 illustrates an example of an audio connector according to various embodiments of this disclosure;

FIGS. 5A and 5B (collectively, “FIG. 5”) illustrate an example of an audio connector according to certain embodiments of this disclosure;

FIGS. 6A and 6B (collectively, “FIG. 6”) illustrate examples of the operation of audio connectors according to certain embodiments of this disclosure;

FIG. 7 illustrates an example of a mute switch according to various embodiments of this disclosure; and

FIG. 8 illustrates an example of an insulating collar according to some embodiments of this disclosure.

### DETAILED DESCRIPTION

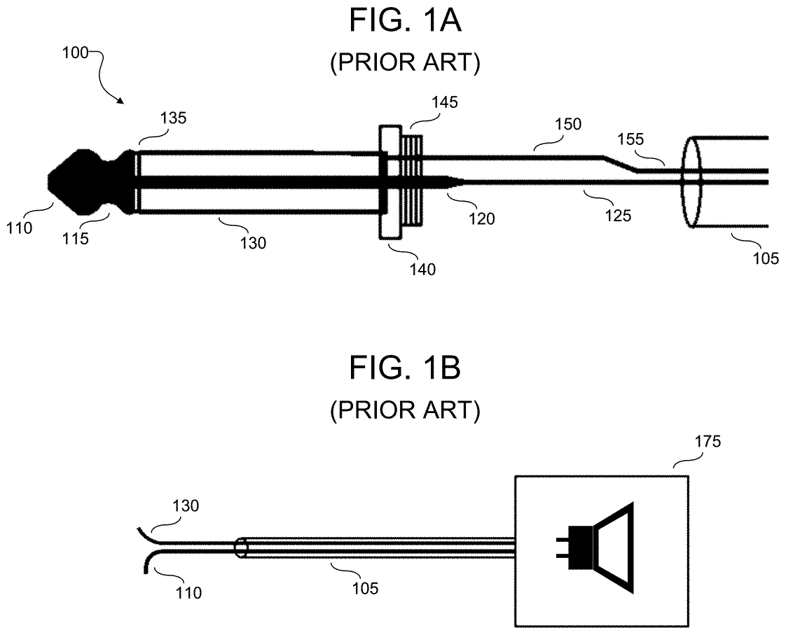

FIGS. 1A through 8, discussed below, and the various embodiments used to describe the principles of the present disclosure are by way of illustration only and should not be construed in any way to limit the scope of the disclosure.

FIGS. 1A and 1B illustrate an example of a tip-socket (“TS” or “phone”) plug and a simplified circuit illustrating aspects of the technical challenges addressed by certain embodiments according to this disclosure.

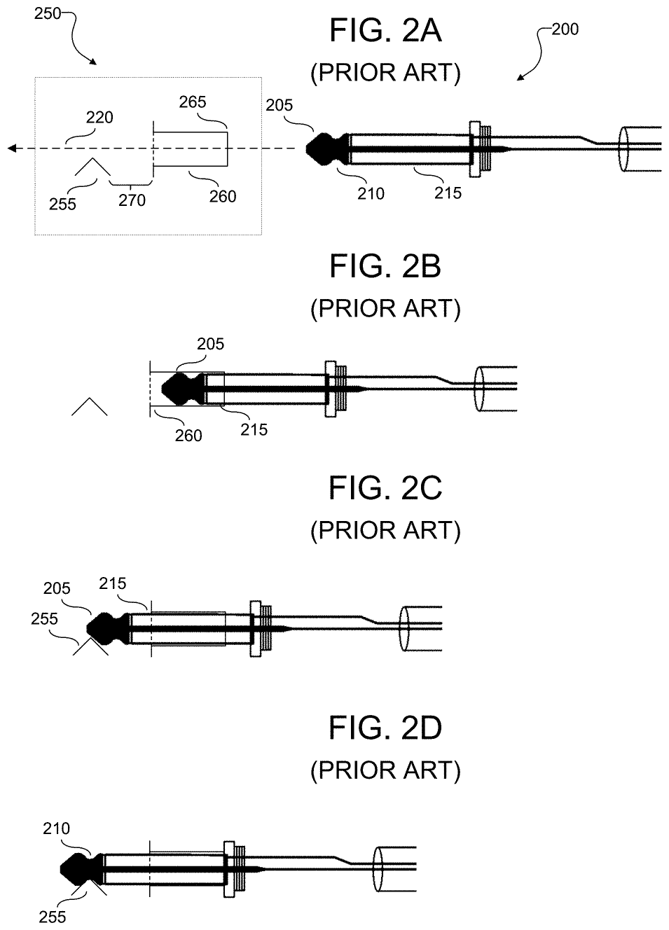

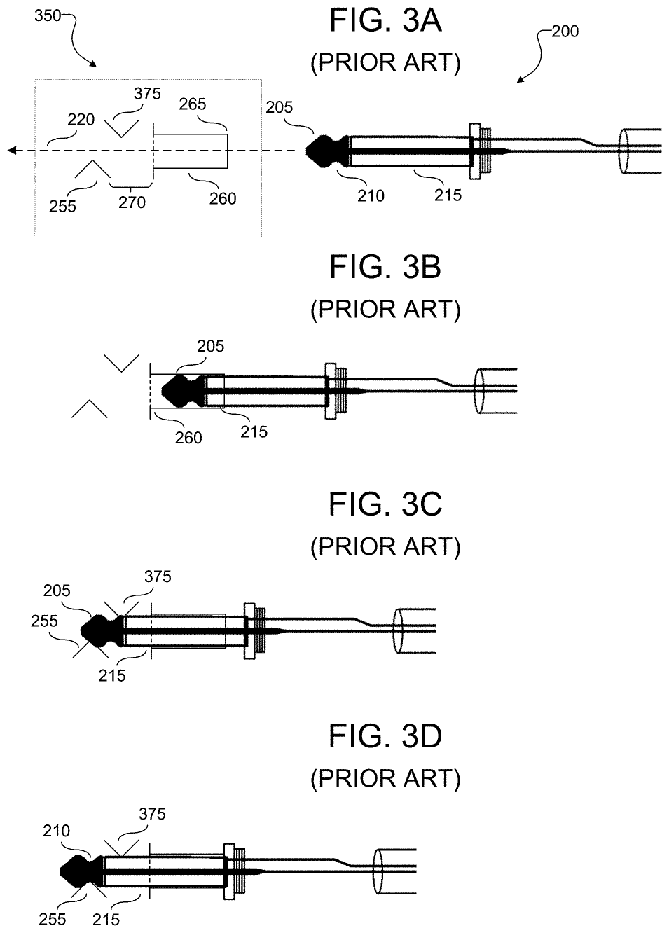

Referring to the non-limiting example of FIG. 1A, an example of TS plug 100 is shown in the figure. As shown in this illustrative example, TS plug 100 comprises one end of an interconnect 105 (for example, a coaxial cable) for connecting two audio components, such as an electric instrument and further signal processing means (for example, an effects pedal, a mixer or an amplifier head). As described in greater detail with reference to FIGS. 2A-3D of this disclosure, TS plug 100 is designed to be inserted axially into a phone jack to complete one end of a connection between the audio components.

As shown in the non-limiting example of FIG. 1A, TS plug 100 comprises a tip portion 110 comprising a section of conductive material (for example, nickel, brass, chrome or gold-plated metal) having an external portion with a blunted onion-dome profile which includes a groove shaped retaining portion 115. Tip portion 110 further comprises an internal portion 120 (sometimes also referred to as a “core”) to which an electrical connection (for example, a solder joint) to a first lead 125 of interconnect 105 is formed. Typically, tip portion 110 and first lead 125 are connected to the signal line (for example, the “hot” wire of a single coil guitar pickup) of an audio component connected by interconnect 105.

In this illustrative example, TS plug 100 also includes a sleeve portion 130, comprising a hollow section of conductive material (for example, nickel, brass, chrome or gold plated metal) having an external diameter substantially similar (typically, ¼ inch) to that of tip portion 110 at its widest, and an internal diameter similar, or slightly greater than the external diameter of insulating sleeve 135. In some embodiments, sleeve portion 130 further includes a bezel portion 140 which comprises a flange to prevent overinsertion of the plug into a ¼″ jack, as well as a threaded portion 145 to which an external cover (not shown) to conceal the connections between jack and the conductors of interconnect 105 attaches. Further, as shown in the explanatory example of FIG. 1A, sleeve portion comprises a conducting protrusion 150 to which an electrical connection (for example, a soldered joint) with a second conductor 155 of interconnect 105 is formed. Conventionally, second conductor 155 forms a ground connection between the audio components connected through TS plug 100 and interconnect 105.

Additionally, TS plug 100 includes insulating sleeve 135, which comprises a hollow section of insulating material, comprising an internal sleeve to electrically separate internal portion 120 of tip portion 110 from the inside of sleeve portion 130, and a flange portion electrically separating tip portion 110 from sleeve portion along a central axis of TS plug 100.

FIG. 1B illustrates an example of certain technical problems solved by various embodiments according to this disclosure. For convenience of cross-reference, components common to the examples of FIG. 1A are numbered similarly in FIG. 1B.

Referring to the illustrative example of FIG. 1B audio interconnect 105 is connected to audio amplifier 175, which is configured to convert electrical signals from audio interconnect 105 into audible (sometimes, very audible) sounds, through an amplification circuit and one or more audio speakers. In this example, while one end of audio interconnect 105 is electrically connected to audio amplifier 175, the other end, comprising a standard TS plug (for example, TS plug 100 in FIG. 1A) is not connected to anything, and tip portion 110 and sleeve portion 130 form two ends of an open circuit. Audio amplifier 175 is configured to reproduce as sound, changes in electrical potential between tip portion 110 and sleeve portion 130. When TS plug 100 is not connected to the ground and signal leads of another circuit, the potential difference between tip portion 110 and 130 floats. In practical terms, this means that audio amplifier 175 reproduces sounds associated with ambient and undesired sources of potential difference between the two terminals of TS plug 100, such as the 60 cycle hum of the lights in a room, or “tapping” sounds associated with intermittent contact between tip portion 110 and a user's body. Additionally, when tip portion 110 and sleeve portion 130 are electrically connected and disconnected, there can be transient spikes in the potential difference between the two, which are reproduced by audio amplifier 175 as a “popping” sound. Depending on the level of amplification provided by audio amplifier 175, the above-described “popping” sound generated while inserting or removing a TS plug from a phone jack of a hot amplifier can be damaging to both hearing and equipment.

Accordingly, an audio plug which eliminates the possibility of making “popping” sounds under load, while at the same time, satisfying the functional and design constraints of required by serious musicians represents a clear opportunity for improvement in the art. As to the functional and design constraints, these include, for example, compatibility across jack types (for example, mono and stereo phone jacks), durability to withstand rough handling during travel and repeated use. A further functional constraint is that, many musicians are fastidious about the components along their signal chains, as evidenced by, for example, the significant premiums charged for new old stock (“NOS”) vacuum tubes for amplifiers and effects, or vintage paper-in-oil “Bumble Bee” style capacitors. As such, adding unspecified electronic components, such as reed switches or the like is unacceptable to signal-chain conscious musicians.

FIGS. 2A through 2D illustrate aspects of some technical problems addressed by certain embodiments of this disclosure. For convenience of cross reference, elements common to more than one of FIGS. 2A through 2D are numbered similarly.

In the illustrative examples of FIGS. 2A through 2D, various stages of the insertion of TS plug 200 into mono TS jack 250 along an insertion path 220 are shown in figures, starting from the fully disconnected state shown in FIG. 2A, to the partially inserted states shown in FIGS. 2B and 2C, to fully inserted in FIG. 2D.

Referring to the illustrative example of FIG. 2A, a TS plug 200 (for example, TS plug 100 in FIG. 1A) is shown on the right side of the figure. TS plug 200 comprises, without limitation, a tip portion 205 (for example, tip portion 110 in FIG. 1A) comprising a retaining portion 210 configured to interface with a tip contact 255 of mono TS jack 250. TS plug 200 further comprises a sleeve portion 215 (for example, sleeve portion 130 in FIG. 1A) configured to interface with sleeve contact 260 of mono TS jack 250.

As shown in FIG. 2A, mono TS jack 250 comprises a sleeve contact 260, comprising a hollow portion of conductive material with an outer end 265, comprising the first potential point of conductive contact between TS plug 200 and mono TS jack 250. Mono TS jack 250 is configured to be electrically connected to a first conductor (typically, a ground lead) of a circuit of an audio component (for example, an electric guitar) to be connected to another component through TS plug 200.

Mono TS jack 250 further comprises a tip contact 255, comprising a section of flexible, conductive material with a “V” shaped profile configured to nest within the space of retaining portion 210 of TS plug 200. Typically, tip contact 255 is part of a cantilevered section of the flexible, conductive material which is deflected downward upon initial contact with tip portion 205 and, upon sufficient insertion of TS plug 200 into mono TS jack 250 springs up to lock into the groove of retaining portion 210. As shown in this illustrative example, there is a gap 270 between an end portion of sleeve contact 260 and the first point of potential contact between TS plug 200 along insertion path 220.

Although the present disclosure has been described with various embodiments, various changes and modifications may be suggested to one skilled in the art. It is intended that the present disclosure encompass such changes and modifications as falling within the scope of the claims.

Attention is directed to FIG. 2B, which illustrates certain spatial relationships between the conductive components of TS plug 200 and mono TS jack 250 when TS plug 200 is partially inserted. As shown in this illustrative example, when TS plug 200 is initially inserted into mono TS jack 250, both tip portion 205 and sleeve portion 215 are within the hollow conductive cylinder of sleeve contact 260. Depending on a variety of factors, including, without limitation, the manufacturing tolerances, state of wear, and general looseness or tightness of the fit between TS plug 200 and mono TS jack 250, tip portion 205 and sleeve portion 215 may, or may not be electrically connected through sleeve contact 260.

Given the multiple factors affecting the extent to which tip portion 205 and sleeve portion 215 are electrically connected through sleeve contact 260 when TS plug is partially inserted, FIG. 2B illustrates a situation associated with a strong likelihood of generating transient signals associated with opening and closing an electrical connection between the tip and sleeve portions of TS plug 200, and by implication, the likelihood of loud, dissonant “pops” when such signals are reproduced by a hot amplifier.

Accordingly, certain prior designs for noiseless TS plugs have provided switches designed to maintain a closed circuit between tip portion 205 and sleeve portion 215 while TS plug is inserted as shown in FIG. 2B. Examples of such switches include switches with a sliding sleeve surrounding the sleeve portion which retracts into a bezel portion (for example, bezel portion 140 in FIG. 1A) as TS plug 200 approaches full insertion. Moving the sliding sleeve back actuates a switch connecting the tip and sleeve portions of the plug such that the electrical connection provided by the switch is broken when a requisite degree of insertion has been achieved. When relatively new, such switches can perform well and reliably prevent “popping” during insertion of TS jacks. However, the sliding sleeve mechanism is susceptible to wear, accumulation of dirt in the narrow space between the sleeve portion and the sliding collar, and reliably and performance have been observed to drop off with use.

FIG. 2C illustrates certain spatial relationships between the conductive parts of TS plug 200 and TS jack 250 as TS plug 200 is advanced further along insertion path 220 to an insertion distance corresponding to the “pop point” for mono TS jack 250.

As used in this disclosure, the expression “pop point” encompasses a point along an intended insertion path (for example, insertion path 220 in FIG. 2A) of a TS plug in a TS jack at which tip portion 205 and sleeve portion 215 of TS plug 200 begin to be in conductive contact with their counterpart contacts in a TS jack. Referring to the illustrative example of FIG. 2C, in mono TS jack 250, the “pop point,” is the point of insertion where tip portion 205 is only contacting tip contact 255, and sleeve portion 215 is only in conductive contact with sleeve contact 260. Referring to the illustrative examples of FIGS. 2C and 2D, inserting TS plug 200 beyond the “pop point” brings TS plug towards full insertion, wherein tip contact 255 engages with retaining portion 210 to securely retain TS plug 200 in mono TS jack 250, while pulling TS plug 200 out, and away from the “pop point” draws it towards configurations where intermittent electrical contact between tip portion 205 and sleeve portion 215 becomes possible.

FIG. 2D illustrates some spatial relationships between conductive surfaces of TS plug 200 and mono TS jack 250 when TS plug 200 is fully inserted.

As shown in the example of FIG. 2D, when fully inserted, tip contact 255 of TS jack 250 sits in retaining portion 210 and provides resistance against withdrawal of TS plug 200.

FIGS. 3A through 3D illustrate further aspects of some technical problems solved by embodiments according to this disclosure. For convenience of cross-reference, elements in FIGS. 3A through 3D which have already been described with reference to the examples of FIGS. 2A through 2D are numbered similarly.

As will be illustrated through the examples of FIGS. 3A through 3D, in addition to achieving high levels of ruggedness and durability, while at the same time, operating in a manner compatible with a variety of jack types, including mono TS jacks (for example, mono TS jack 250 in FIG. 2A) and stereo jacks. Specifically, the “pop points” of different TS jacks, in particular mono versus stereo jacks, varies sufficiently meaningfully that “silent” TS plug designs primarily designed for mono TS jacks do not reliably disengage an electrical connection between the tip and sleeve portion of the plug until the “pop point” has been crossed. Similarly, and as discussed with reference to FIG. 2C, while TS plugs with switches that are actuated by contact between a ring or finger extending from a bezel portion of the plug and the leading edge of the sleeve portion of a TS jack are susceptible to wear and contaminants restricting the switch actuator's ability to retract into the bezel portion of the plug.

Referring to the explanatory example of FIG. 3A, a stereo jack 350 is shown at the left side of the figure, and TS plug 200 is shown at the right hand side of the figure. In contrast to mono TS jack 250 in FIG. 2A, stereo jack 350 comprises an additional contact point, ring contact 375, configured to provide a third point of electrical contact between a TS plug and stereo jack 350. For example, in some embodiments, stereo jack 350 may be configured to receive a stereo, or tip-ring-sleeve (“TRS”) phone plug, in which case, one signal of a stereo pair is provided through tip contact 255 of stereo jack 350, a second signal is provided through ring contact 375, and sleeve contact provides a common ground. As another example, ring contact 375 and sleeve contact 260 may operate as ends of a power circuit which is closed when both ring contact 375 and sleeve contact 260 are connected by sleeve portion 215 of TS plug 200. The latter configuration is often used for the output jacks of musical instruments (for example electric-acoustic guitars, ukuleles and the like) with active pickups, wherein insertion of a TS plug cable completes a circuit providing power to the preamp and other onboard electronics of the instrument.

As shown in the explanatory example of FIG. 3B, when mono TS plug 200 is partially inserted into stereo jack 350, when tip portion 205 and sleeve portion 215 of the plug are both inside of the inner portion of sleeve contact 260 and depending on a variety of factors, such as the looseness of the fit between plug and sleeve, tip portion 205 and sleeve portion 215 may or may not be electrically connected by sleeve contact 260 of stereo jack 350. As such, stereo jacks, like mono TS jacks are prone to producing crackling and popping sounds during connection to a hot amplifier.

Referring to the explanatory example of FIG. 3C, in this example, TS plug 200 is inserted into stereo jack 350 at an insertion depth corresponding to the “pop point” for mono TS jack 250 in FIG. 2C. However, as shown in FIG. 3C, the insertion depth shown in FIG. 2C as corresponding to the “pop point” for mono jack 250 does not correspond to the insertion depth corresponding to the “pop point” for stereo jack 250. Instead, as shown in FIG. 3C, at certain points along insertion path 220, ring contact 375 can temporarily electrically connect tip portion 205 and sleeve portion 215, creating opportunities for creating the loud “popping” sounds associated with transient connections between tip portion 205 and sleeve portion 215. For stereo jacks, such as stereo jack 350, the “pop point” lies further along insertion path 220, at the point where ring contact 275 is only in electrical contact with sleeve portion 215.

FIG. 3D illustrates some spatial relationships between conductive elements of TS plug 200 and stereo jack 350 when TS plug 200 is fully inserted. As shown in the figure, at full insertion, tip contact 255 sits in the groove of retaining portion of tip portion 205 to provide a threshold level of resistance against pulling TS plug 200 out along insertion path 220. Additionally, when TS plug 200 is fully inserted, ring contact 375 is only in electrical contact with sleeve portion 215.

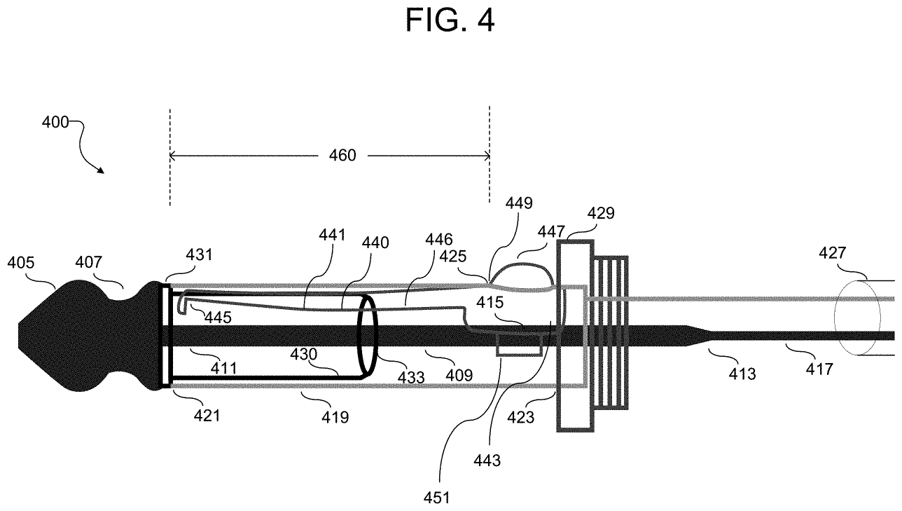

FIG. 4 illustrates an example of an audio connector 400 according to various embodiments of this disclosure.

Referring to the non-limiting example of FIG. 4, audio connector 400 comprises a plug configured to consistently maintain an electrical connection between a tip portion and sleeve portion of the connector until the connector has passed the “pop point” for a stereo jack (for example, stereo jack 350 in FIG. 3A). Further, as will be described further, audio connector 400 utilizes a simple, rugged design that avoids the use of buttons or sleeves retracting into a bezel portion of the plug (and which are susceptible to rapid wear and fouling), as well as additional electrical components (for example, reed switches) on, or along, the signal chain of which audio connector 400 is a part.

As shown in the explanatory example of FIG. 4, audio connector 400 comprises a tip member 405, which is formed of a section of conductive material (for example, brass, nickel, gold, chrome, or mixtures thereof), having an external portion with an external profile defining a tip and a retaining portion 407. According to certain embodiments, retaining portion 407 comprises a radial groove behind the tip on the external portion of the tip member. In some embodiments, the external portion of tip member has a length of 8.5 millimeters as measured along the centerline of audio connector 400, and an external diameter of slightly less than a quarter of an inch (for example, 6.2 mm) at its widest, and an internal diameter of 3.9 mm at the narrowest point of retaining portion 407.

Additionally, and as shown in the example of FIG. 4, tip member 405 further comprises an internal portion 409 (sometimes also referred to as a “core”) having a first end 411 and a second end 413 and a switch region 415 disposed between first end 411 and second end 413. As shown in FIG. 4, first end 411 abuts the external portion, and second end 413 is configured to form a first connection with a first section (for example, a wire or section of conductive sheathing) of a cable.

Referring to the non-limiting example of FIG. 4, audio connector 400 further comprises a sleeve member 419, comprising a substantially cylindrical hollow section of conductive material (for example, steel, brass, nickel, gold or chrome plated metals), which has a first end 421 proximate to tip member 405. According to certain embodiments, sleeve member 419 has an external diameter of 6.35 mm, and an internal diameter sufficient to allow a switching lobe and switch portion of a mute switch to deflected into the interior of sleeve member 419 when audio connector is fully inserted into a jack. According to certain embodiments, sleeve member 419 has an internal diameter of at least 5.2 mm.

As shown in the illustrative example of FIG. 4, sleeve member 419 comprises a second end 423 distal to tip member 405. According to various embodiments, the distance between first end 421 and second end 423 is 21.9 mm. Further, in some embodiments, the distance from second end 423 to the end of tip member 405 is 31 mm, which generally corresponds to the 1.25 inch standard insertion length for ¼ inch TS plugs.

In some embodiments, sleeve member 419 also comprises a through-hole 425 proportioned to allow the passage of a switching lobe of a mute switch to move between a “popped up” state when audio connector 400 is unplugged, to being depressed substantially flush to the exterior of sleeve member 419 when audio connector 400 is inserted past the “pop point” of a stereo jack. According to various embodiments, through-hole 425 has an elongated shape, with a length (measured along an axis parallel to the direction of insertion of audio connector 400) greater than its width (measured along an axis perpendicular to the direction of insertion of audio connector 400). In some embodiments, through-hole 425 had an even shape, which is of equal width and length, and in other embodiments, through-hole 425 is wider than it is long. In some embodiments, through-hole 425 is at least 18 millimeters away from first end 421 of sleeve member 419 and has a length of 4 millimeters or less and a width of 2.6 millimeters or less. As discussed herein, the proportions of through-hole 425 can depend on a variety of factors, including the thickness of an insulator between sleeve member 419 and tip member 405, and the shape of the switching lobe of the mute switch. As shown in the explanatory example of FIG. 4, sleeve member 419 is configured to form a second connection with a second section of a cable 427. In many applications, where tip member 405 is configured to connect with the section of a cable through which an audio signal is provided, sleeve member 419 is configured to connect to the conductor of the cable (for example, a conductive sheath) providing ground for the circuit.

According to certain embodiments, sleeve member 419 further comprises a bezel portion 429, which abuts second end 423 and has a larger diameter than a sleeve contact of a jack. Depending on embodiments, bezel portion 429 may have a threaded portion, to which an external cover can attach to sleeve member 419 (thereby covering connections between audio connector 400 and the conductors of the cable to which it is attached). In some embodiments, bezel portion 429 may have barbs, ribs or other surface features to facilitate attachment to a non-threaded cover (for example, a molded plastic cover).

Referring to the non-limiting example of FIG. 4, audio connector 400 further comprises an insulating collar 430. According to various embodiments, insulating collar 430 comprises one or more substantially cylindrical, hollow sections of one or more insulating materials (for example, nylon, rubber, plastic, phenolic, mica, fiberglass or polytetrafluoroethylene (“PTFE”)) As shown in FIG. 4, insulating collar 430 includes a first end 431 which comprises a flange that electrically isolates the external portion of tip member 405 from sleeve member 419. Additionally, insulating collar 430 comprises a second end 433 distal to first end 431. According to various embodiments, the flange portion has an exterior radius of 6.35 mm. The thickness of the flange portion, as measured along an axis parallel to the direction of insertion of audio connector 400 varies across embodiments, and can depend, without limitation, on the position and shape of a connecting lobe of the mute switch used. In some embodiments, the flange portion of insulating collar 430 has a thickness of 1.7 mm, which corresponds to the typical length (along the axis of insertion) of the insulator between a tip and sleeve in a standard, non-silent TS plug. That said, the inventors have found that reducing the thickness of the flange portion of insulating collar 430 can be conducive to plug geometries which offer consistent performance across both mono and stereo jacks, while at the same time, situating a switching lobe of the mute switch at a location associated with reliable actuation.

In certain embodiments, the flange portion of insulating collar has a thickness of less than 1.7 mm, such as between 1.7 and 1.0 mm. In other embodiments, the flange has a thickness between 0.7 and 1.0 mm, and in various embodiments, the flange has a thickness between 0.5 and 0.7 mm. For example, in one prototype, an insulating collar with a flange thickness of 0.6 mm was used with consistently reliable performance across all tested jack types, including both mono and stereo jacks.

According to certain embodiments, insulating collar 430 has, in the non-flange portion of the collar, an exterior radius that is less than an interior radius of sleeve member 419. For example, in certain embodiments, the external radius of the non-flange portion of insulating collar is on the order of 5.45 mm. Additionally, insulating collar 430 has an interior radius which is greater than the thickness of internal portion 409 of tip member 405, such that internal portion 409 of tip member 405 passes through the hollow interior of insulating collar 430. According to certain embodiments, the interior diameter of insulating collar 430 is on the order of 3.5-4.0 mm.

While, in the illustrative example of FIG. 4, insulating collar 430 has been described with reference to an example, wherein the part is formed from a single piece of insulating material, embodiments according to this disclosure are not so limited. In some embodiments, insulating collar 430 may be formed from two or more pieces of insulating material (for example, an external washer and an internal sleeve) without departing from the spirit of this disclosure.

Referring to the non-limiting example of FIG. 4, audio connector 400 comprises a mute switch 440, which operates to maintain an electrical connection between tip member 405 and sleeve member 419 until audio connector 400 has been inserted past the “pop point” of either a mono or stereo jack. Further, as will be described in detail herein, the configuration of components, in particular insulating collar 430 and mute switch 440, in certain embodiments according to this disclosure offer an overall improvement in performance over existing silent audio connectors. In other words, audio connectors according some embodiments do not require users to compromise on one or more of compatibility across jack types, durability and excluding unwanted components from a signal chain.

As shown in FIG. 4, mute switch 440 comprises a section of a flexible, conductive material (for example, gold, nickel or chrome plated steel). According to various embodiments, mute switch 440 comprises a retaining portion 445 with an interior profile configured to contact an exterior profile of insulating collar 430, and an exterior profile configured to conductively contact an interior profile of sleeve member. Put differently, the retaining portion of mute switch 440 is configured to be pinned between insulating collar 430 and sleeve member 419 such that mute switch 440 and insulating collar 430 are maintained at the same electrical potential. According to some embodiments, insulating collar 430 comprises one or more recesses or notches, into which a cleat or other protruding sections of retaining portion 445 of mute switch 440 nest to securely retain mute switch 440 within audio connector 400. In certain embodiments, mute switch 440 has an overall length of ˜20 mm.

According to certain embodiments, mute switch 440 further comprises a switch arm portion 446 with a first end 441 and a second end 443, which, when mute switch 440 is inside of sleeve member 419 and retaining portion 445 is sandwiched between insulating collar 430 and the interior of sleeve member 419, comprises a preloaded spring pushing a switching lobe 447 through through-hole 425, such that switching lobe 447 protrudes beyond the outer radius of sleeve member 419 when audio connector 400 is not inserted into an audio jack beyond the “pop point” of a stereo audio jack.

According to certain embodiments, switching lobe 447 comprises a protrusion having a ramped, or cam-like external profile comprising a leading edge 449 configured to initially engage with the sleeve contact (for example, sleeve contact 260 in FIG. 3A) as audio connector 400 is inserted into a jack. As audio connector 400 is more fully inserted into the audio jack, the interface between switching lobe 447 and the sleeve contact follows the cam-like shape of switching lobe 447, causing switching lobe 447 to be depressed into sleeve member 419. In some embodiments, switching lobe 447 has a length (along an axis parallel to the direction of insertion) which is greater than a width (measured along an axis perpendicular to the direction of insertion). For example, in embodiments in which through-hole 425 has a length of 3.8 mm, switching lobe 447 has a length of 3.5 mm, and where through hole 425 has a width of 2.6 mm, switching lobe 447 has a width of 2.5 mm, when switching lobe 447 is fully protruded. Testing has shown that the above described 0.05-0.1 mm gap between switching lobe 447 and through-hole 425 is associated with reliable performance. Additionally, in certain embodiments, the overall height of switching lobe 447 (including portions within sleeve member 419 when switching lobe 447 is fully protruded) is between 0.8 and 1.1 mm.

As shown in the non-limiting example of FIG. 4, mute switch 440 further comprises a contact arm portion 451 disposed near second end 443 of switch arm portion 446. According to various embodiments, contact arm portion 451 comprises a “C” or “J” shaped section of conductive material extending away from switching lobe 447 towards switch region 415 of the internal portion 409 of tip member 405. Further, contact arm portion 451 is proportioned to contact switch region 415, thereby forming a closed circuit, when the switching lobe is not sufficiently depressed (such as being inserted past the “pop point” of a stereo jack). In this way, certain embodiments according to the present disclosure maintain a closed circuit between the tip and sleeve portions of audio connector 400 until the connector has been inserted past the “pop point” of a stereo jack, thereby avoiding the problem of loud “pops” when audio connector 400 is connected to a “hot” audio amplifier. Similarly, the contact arm portion 451 is proportioned to release electrical contact between contact arm portion 451 and switch region 415 (and any other portion of tip member 405) when the switching lobe is sufficiently depressed.

According to various embodiments, mute switch 440 can provide a combination of durability and reliable actuation across multiple jack types not provided by prior designs, as well as not introducing unwanted electrical or electronic components into a signal chain, beyond what existing designs, including those utilizing either reed switches, or switches actuated by sliding collars can provide. In certain embodiments, to ensure that the electrical connection between tip member 405 and sleeve member 419 provided by mute switch 440 is not broken until audio connector 400 has been inserted past the “pop point” of the jack, in particular, a stereo jack, leading edge 449 of switching lobe 447 is maintained at a first distance 460 with the first end 421 of sleeve member 419. According to various embodiments, first distance 460 is at least 18.4 millimeters. In some embodiments, first distance 460 is between 18.5 and 19 millimeters. In certain embodiments, the first distance is between 19 and 19.5 millimeters. In various embodiments, the first distance is between 19.5 and 20 millimeters, and in some embodiments, the first distance is greater than 20 millimeters (for example, 20.5 millimeters).

In certain embodiments, the length of sleeve member 419 as measured from the bezel portion 429 to first end 421 is greater than the ˜20.5-20.8 mm standard distance for conventional plugs. In this way, switching lobe 447 can either be positioned further back (relative to first end 421) which has been found to be conducive to ensuring that the electrical connection between tip member 405 and sleeve member 419 through mute switch 440 is not broken until audio connector 400 has been inserted past the “pop point” of a stereo jack.

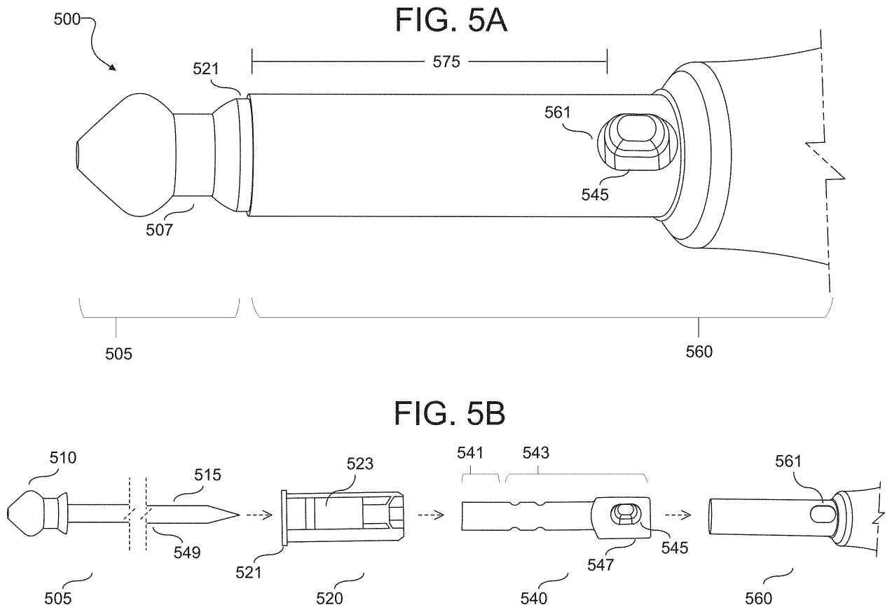

FIGS. 5A and 5B (collectively, “FIG. 5”) illustrate an example of an audio connector 500 according to certain embodiments of this disclosure. FIG. 5A illustrates an assembled external view of audio connector 500, while FIG. 5B illustrates an exploded view of audio connector 500. For convenience of cross-reference, elements common to both FIGS. 5A and 5B are numbered similarly. The dashed arrows in FIG. 5B indicate that the parts shown in the figure nest together within the interior of sleeve member 560.

Referring to the non-limiting example of FIG. 5, audio connector 500 comprises a silent audio connector (for example, audio connector 400 in FIG. 4) according to various embodiments of this disclosure. According to certain embodiments, audio connector 500 comprises a tip member 505 comprising an external portion 510, an internal portion 515 and a radial groove 507.

As shown in this illustrative example, internal portion 515 passes through a hollow center of insulating collar 520, which comprises, without limitation, a flange 521 having a thickness ranging, depending on the length of the sleeve member and position of switching lobe, between 0.6 and 1.7 millimeters. Further, as shown in the exploded view, insulating collar 520 an exterior radius less than an interior radius of the sleeve member of audio connector 400. As used in this disclosure in the context of this disclosure, the expression “exterior radius” as used with respect to insulating collar 520 does not necessarily imply that insulating collar 520 has a cylindrical shape, and embodiments in which the exterior of insulating collar 520 has reliefs or corners are within the contemplated scope of this disclosure. For example, as shown in FIG. 5B, the exterior of insulating collar 520 comprises a longitudinal external channel 523 comprising further lateral recesses, which operate to securely retain the retaining portions of mute switch 540.

According to various embodiments, audio connector 500 comprises a mute switch 540, comprising a section of conductive material with a retaining portion 541 and a switch arm portion 543. Further, as shown in this explanatory example, switch arm portion 543 comprises a switching lobe 545, which is configured to pass through a through-hole of the sleeve member. As shown in the figure, switch arm portion 543 further comprises a contact arm portion 547 configured to contact a switch region 549 of tip member 505.

Referring to the illustrative example of FIG. 5, audio connector 500 further comprises a sleeve member 560, comprising a hollow section of a conductive material. As shown in the figure, sleeve member 560 further comprises a through-hole 561, through which switching lobe 545 is configured to pass through. As shown in FIG. 5A, switching lobe 545 passes through through-hole 561 such that the leading edge of switching lobe 545 is disposed at a first distance from the end of sleeve member 560. According to certain embodiments first distance 575 is at least 18.4 millimeters, to maximize the probability that when switching lobe 545 is depressed to the point where mute switch 540 no longer forms an electrical connection between tip member 505 and sleeve member 560, audio connector has been inserted past the “pop points” of mono and stereo jacks.

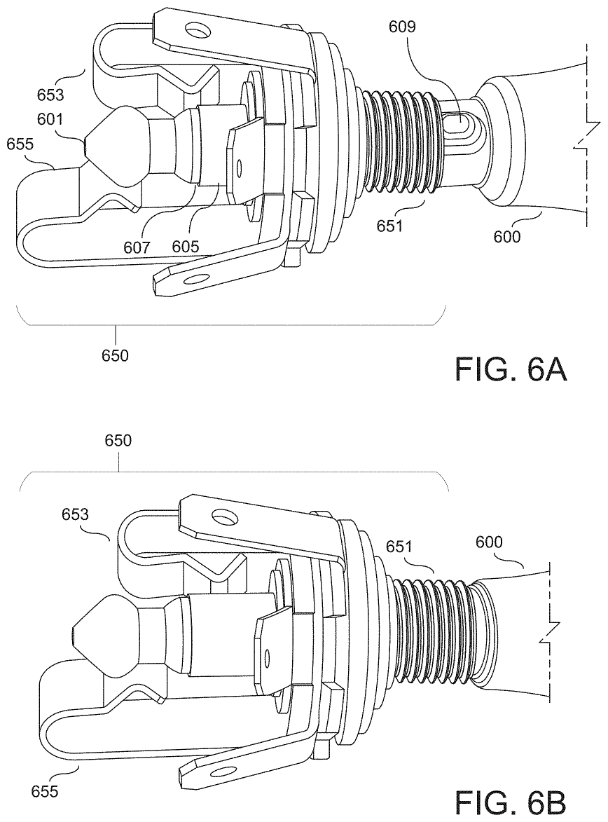

FIGS. 6A and 6B (collectively, “FIG. 6”) illustrate examples of the operation of audio connectors according to certain embodiments of this disclosure. For convenience of cross-reference, elements common to both figures are numbered similarly.

Referring to the non-limiting example of FIG. 6, an audio connector 600 according to certain embodiments of this disclosure (for example, audio connector 400 in FIG. 4, or audio connector 500 in FIG. 5) are shown, along with a stereo jack 650. As shown in the illustrative example of FIG. 6, stereo jack 650 comprises a sleeve contact 651, a ring contact 653, and a tip contact 655.

FIG. 6A shows audio connector inserted in stereo jack 650 at the “pop point” for stereo jack 650. As shown in the figure, both the tip member 601 and sleeve member 605 are contacting ring contact 653 on either side of insulating collar 607. Accordingly, ring contact 653 can act as a temporary conductive bridge between tip member 601 and sleeve member 605, which, if stereo jack 650 were connected to a live amplifier, could be a source of unwanted crackling and popping in a standard TS plug. Note also, that the insertion point shown in FIG. 6A is well past the “pop point” of a mono TS jack, as tip member 601 is already exclusively contacting tip contact 655. However, as shown in the illustrative example of FIG. 6A, even if stereo jack 650 is connected to a live amplifier, audio connector 600 will not produce any crackling or popping due from signals created between intermittent shorting of tip member 601 and sleeve member 605. This is because, as shown in FIG. 6A, in certain embodiments according to this disclosure, the leading edge of switching lobe 609 is only beginning to engage with the open end of sleeve contact 651. As such, the mute switch in audio connector 600 remains closed at the “pop point” of stereo jack 650.

FIG. 6B shows the relative locations of conductive surfaces of audio connector 600 and stereo jack 650 when audio connector 600 is fully inserted, causing switching lobe 609 to be fully depressed, thereby breaking the electrical connection between tip member 601 and sleeve member 605 created by the mute switch of audio connector 600. As shown in the illustrative examples of FIGS. 6A and 6B, by the time the crest, or center point of switching lobe 609 is inserted into the open end of sleeve contact 651, audio connector 600 has been inserted past the “pop point” of stereo jack 650, with ring contact 653 solely in electrical contact with sleeve member 605, and the structures of stereo jack 650 are no longer able to form a conductive bridge between tip member 601 and sleeve member 605. As shown in this example, certain embodiment according to this disclosure reliably suppress “popping” across both mono and stereo jacks without recourse to sliding external components (which can wear out or get jammed with debris) or unwanted additional electrical components in a signal chain (for example, reed switches).

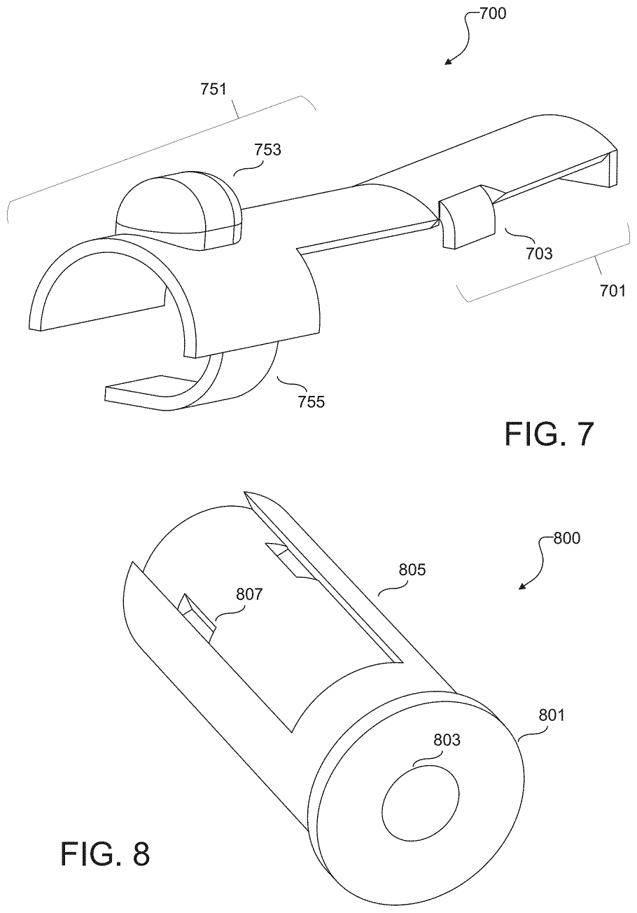

FIG. 7 illustrates an example of a mute switch 700 for use in audio connectors (for example, audio connector 400 in FIG. 4, audio connector 500 in FIG. 5 or audio connector 600 in FIG. 6) according to various embodiments of this disclosure.

Referring to the non-limiting example of FIG. 7, mute switch 700 comprises one or more sections of conductive, resiliently, flexible material (for example, gold or chrome plated spring steel) As shown in FIG. 7, mute switch 700 comprises a retaining portion 701 and a switch arm portion 751. As shown in this illustrative example, retaining portion 701 has an external radius slightly less than that of the interior radius of a sleeve portion (for example, sleeve member 560 in FIG. 5) such that retaining portion 701 can be reliably maintained in conductive contact with a conductive interior surface of a sleeve portion. As shown in FIG. 7, in certain embodiments, retaining portion 701 comprises one or more cleats or prongs 703 to interface with recesses in an insulating collar (for example, insulating collar 800 in FIG. 8) to further retain mute switch 700 within the retaining collar. In some embodiments, retaining portion 701 is approximately 8 mm long, and 2.5 mm wide.

As shown in the illustrative example of FIG. 7, in some embodiments, mute switch 700 further comprises a switch arm portion 751, comprising a cantilevered leaf spring which is anchored at one end by retaining portion 701. In some embodiments, switch arm portion 751 is approximately 12 mm long. According to certain embodiments, switch arm portion 751 further comprises switching lobe 753, which is a raised protrusion (for example, a stamped dimple, or area of increased thickness) having a cam-like, or ramped profile configured to translate the axial motion of an audio connector being inserted into a jack into a compressive force loading up the cantilevered leaf spring of switch arm portion 751.

Referring to the illustrative example of FIG. 7, switch arm portion 751 further comprises a contact arm portion 755, which comprises a “J,” “C” or “U” shaped section of exposed conductive material configured to be held against a switch region of an internal portion of a tip member, when no pressure is applied to switching lobe 753. Similarly, mute switch 700 is configured such that no portion, including contact arm portion 755, of the mute switch contacts any portion of the tip when switching lobe is fully depressed through insertion of an audio connector into a jack.

FIG. 8 illustrates an example of an insulating collar 800 for use in an audio connector (for example, audio connector 400 in FIG. 4, audio connector 500 in FIG. 5, or audio connector 600) according to certain embodiments of this disclosure.

Referring to the non-limiting example of FIG. 8, insulating collar 800 comprises one or more hollow sections of electrically insulating material (for example, nylon, rubber, plastic, phenolic, mica, fiberglass or polytetrafluoroethylene (“PTFE”)). As shown in this illustrative example, at one end, insulating collar 800 comprises a flange 801, which has a thickness, and which axially separates a tip member from a sleeve member of the audio connector. Further, insulating collar 803 is substantially hollow and has an internal diameter proportioned to allow the internal portion of the tip member (also called a “core”) to pass through. Further, as shown in the illustrative example of FIG. 8, insulating collar 800 has an exterior diameter 805 which, when insulating collar 800 is inserted into a sleeve member, is less than or equal to the internal radius of the sleeve member. According to certain embodiments insulating collar 800 may be compressible radially. In some embodiments, insulating collar 800 comprises a channel 807 or other recess structure in the exterior profile comprising structures to interface with counterpart features of a mute switch (for example, cleat 703 in FIG. 7) to help ensure retention of the constituent parts of the audio connector.

The present disclosure should not be read as implying that any particular element, step, or function is an essential element, step, or function that must be included in the scope of the claims. Moreover, the claims are not intended to invoke 35 U.S.C. § 112(f) unless the exact words “means for” are followed by a participle.

1. An audio connector comprising:
a tip;
a sleeve;
an insulating collar comprising a flange having a first thickness, and further comprising an external channel comprising a plurality of recesses; and
a mute switch comprising a section of a flexible, conductive material, a switching lobe passing through a through-hole in the sleeve at a first distance between a leading edge of the switching lobe and the flange of the insulating collar, and a plurality of cleats, wherein each cleat of the plurality of cleats is received by a corresponding recess of the plurality of recesses,
wherein the insulating collar retains and supports the mute switch in conductive contact with the sleeve and tip when the switching lobe is not depressed, and
wherein the mute switch is configured to release conductive contact between the tip and the sleeve when the tip is inserted past a pop point of a stereo audio jack, wherein the pop point of the stereo audio jack comprises an insertion point where a ring contact of the stereo audio jack contacts the sleeve and the tip does not contact the ring contact of the stereo audio jack.

2. The audio connector of claim 1, wherein the first distance is at least 18.4 millimeters.

3. The audio connector of claim 1, wherein the first distance is between 18.5 and 19 millimeters.

4. The audio connector of claim 1, wherein the first distance is between 19 and 19.5 millimeters.

5. (canceled)

6. The audio connector of claim 1, wherein the first distance is greater than 19.5 millimeters.

7. The audio connector of claim 1, wherein the first thickness is 1.7 mm.

8. The audio connector of claim 1, wherein the first thickness is less than 1.7 mm.

9. The audio connector of claim 1, wherein the first thickness is between 1.7 and 1.0 mm.

10. The audio connector of claim 1, wherein the first thickness is between 0.7 and 1.0 mm.

11. The audio connector of claim 1, wherein the first thickness is between 0.5 and 0.7 mm.

12. The audio connector of claim 1, wherein a length of the switching lobe measured along an axis parallel to a direction of insertion of the audio connector is greater than a width of the switching lobe measured along an axis perpendicular to the direction of insertion of the audio connector.

13. The audio connector of claim 12,
wherein the first thickness is between 0.5 and 0.7 mm, and
wherein the first distance is at least 18.5 mm.

14. The audio connector of claim 1, wherein a length of the switching lobe measured along an axis parallel to a direction of insertion of the audio connector is less than or equal to a width of the switching lobe measured along an axis perpendicular to the direction of insertion of the audio connector.

15. The audio connector of claim 14,
wherein the first thickness is between 0.5 and 0.7 mm, and
wherein the first distance is at least 18.5 mm.

16. An audio connector comprising:
tip means;
sleeve means;
insulating collar means comprising a flange having a first thickness, and further comprising an external channel comprising a plurality of recesses; and
mute switch means comprising a switching lobe passing through a through-hole in the sleeve means at a first distance between a leading edge of the switching lobe and the flange of the insulating collar means, and a plurality of cleats, wherein each cleat of the plurality of cleats is received by a corresponding recess of the plurality of recesses,
wherein the insulating collar means retains and supports the mute switch means in conductive contact with the sleeve means when the switching lobe is not depressed, and
wherein the mute switch means are configured to release conductive contact between the tip means and the sleeve means when the tip means is inserted past a pop point of a stereo audio jack, wherein the pop point of the stereo audio jack comprises an insertion point where a ring contact of the stereo audio jack contacts the sleeve means and the tip means do not contact the ring contact of the stereo audio jack.

17. (canceled)

18. The audio connector of claim 16, wherein the first distance is greater than 18.5 mm.

19. The audio connector of claim 16, wherein the first thickness is between 0.5 and 0.7 mm.

20. The audio connector of claim 16, wherein a length of the switching lobe measured along an axis parallel to a direction of insertion of the audio connector is less than or equal to a width of the switching lobe measured along an axis perpendicular to the direction of insertion of the audio connector.

21-22. (canceled)
